(19) United States
(12) Patent Application Publication
(10) Pub. No.: US 2015/0199092 A1
(43) Pub. Date: Jul. 16, 2015

(54) INTELLIGENT WINDOW PLACEMENT

(71) Applicant: Google Inc., Mountain View, CA (US)

(72) Inventors: Alexander Friedrich Kuscher, San Francisco, CA (US); John Nicholas Jitkoff, Palo Alto, CA (US)

(73) Assignee: Google Inc., Mountain View, CA (US)

(21) Appl. No.: 13/627,818

(22) Filed: Sep. 26, 2012

(51) Int. Cl. G06F 3/0484; G06F 3/0481

(52) U.S. Cl. CPC G06F 3/0484; G06F 3/0481

(57) ABSTRACT

A computer-implemented method for managing a display of one or more windows, the method comprising, presenting a first window in a display area, receiving a command to display a second window in the display area and identifying, in response to the command, one or more available locations in the display area, based on the first window presented in the display area. In certain aspects, the method further comprises steps for selecting a display location for the second window, from among the one or more available locations. Systems and computer-readable media are also provided.

### BACKGROUND

The subject technology relates to a user interface for managing windows and particularly, to a window manager for managing the placement of one or more windows.

### SUMMARY

The disclosed subject matter relates to a computer-implemented method for managing a display of one or more windows, the method comprising, presenting a first window in a display area, receiving a command to display a second window in the display area and identifying, in response to the command, one or more available locations in the display area, based on the first window presented in the display area. In certain aspects, the method further comprises steps for selecting a display location for the second window, from among the one or more available locations.

The disclosed subject matter also relates to a system for managing a display of one or more windows, the system comprising one or more processors and a computer-readable medium comprising instructions stored therein, which when executed by the processors, cause the processors to perform operations comprising, presenting a first window in a display area, receiving a command to display a second window in the display area and identifying, in response to the command, one or more available locations in the display area, based on the first window presented in the display area. In certain aspects, the processors are further configured to perform operations comprising selecting a display location for the second window from among the one or more available locations and presenting the second window in the display location, wherein the second window and the first window do not overlap.

The disclosed subject matter also relates to a computer-readable medium comprising instructions stored therein, which when executed by a processor, cause the processor to perform operations comprising, presenting a first window in a display area, receiving a command to display a second window in the display area and identifying, in response to the command, one or more available locations in the display area, based on the first window presented in the display area. In certain aspects, the processors are further configured to perform operations for selecting a display location from among the one or more available locations and presenting the second window in the display location, wherein the second window and the first window do not overlap.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the disclosed aspects. In the drawings:

FIGS. 1A-1D illustrate examples of a display area in which one or more windows can be displayed, according to some aspects of the subject technology.

FIG. 2 illustrates an example of steps of a method for managing the placement one or more windows, according to some aspects of the disclosure.

FIG. 3 illustrates an example of an electronic system that can be used to implement some aspects of the subject disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Aspects of the subject disclosure provide methods, systems and software for presenting and controlling the appearance of windows in a graphical user interface (GUI). Additionally, certain aspects of the subject technology can be used to determine the placement and sizing of newly displayed windows within a display area. As used herein “display area” can include any portion of a GUI that is provided for display to a user.

In certain aspects, the subject technology provides means for identifying free space, or “available locations,” that are not covered by windows in the display area.

In other aspects, the subject technology provides ways to select a most favorable (or optimal) location amongst multiple available locations in which a particular window can be displayed. As will be described in further detail below, the selection of the display location can be based on various considerations, such as the desired window size, content to be displayed in the corresponding window and/or user configurable display preferences. Additionally, aspects of the subject technology can be used to move and/or resize one or more already displayed windows, in order to facilitate the placing of a new window in the most desirable location.

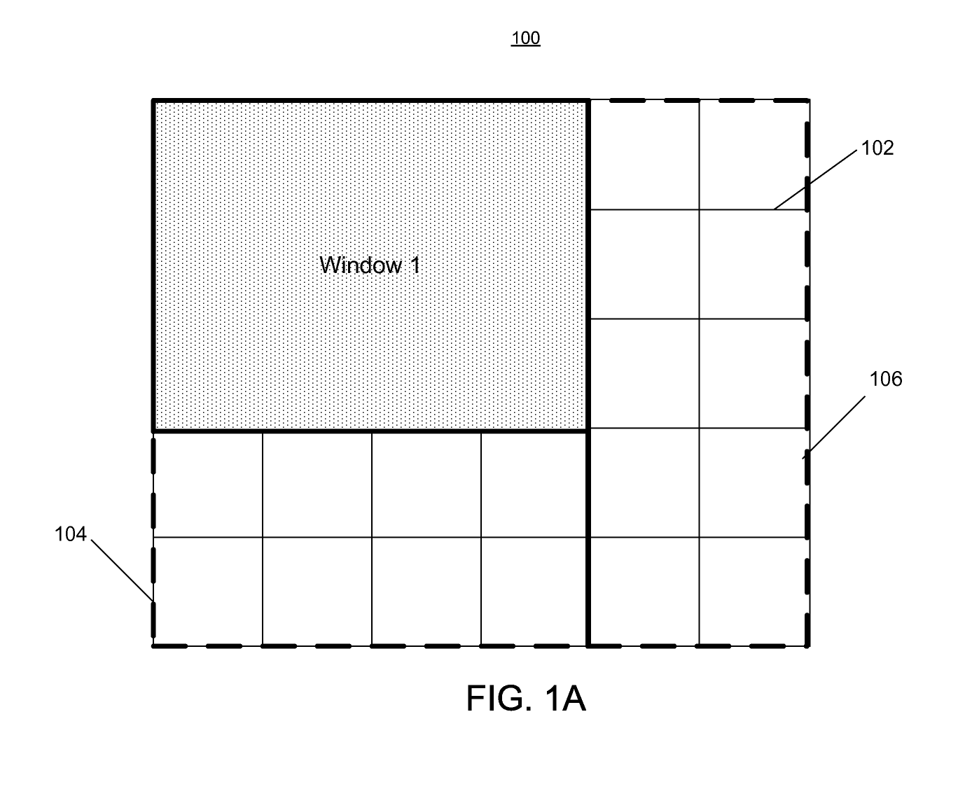

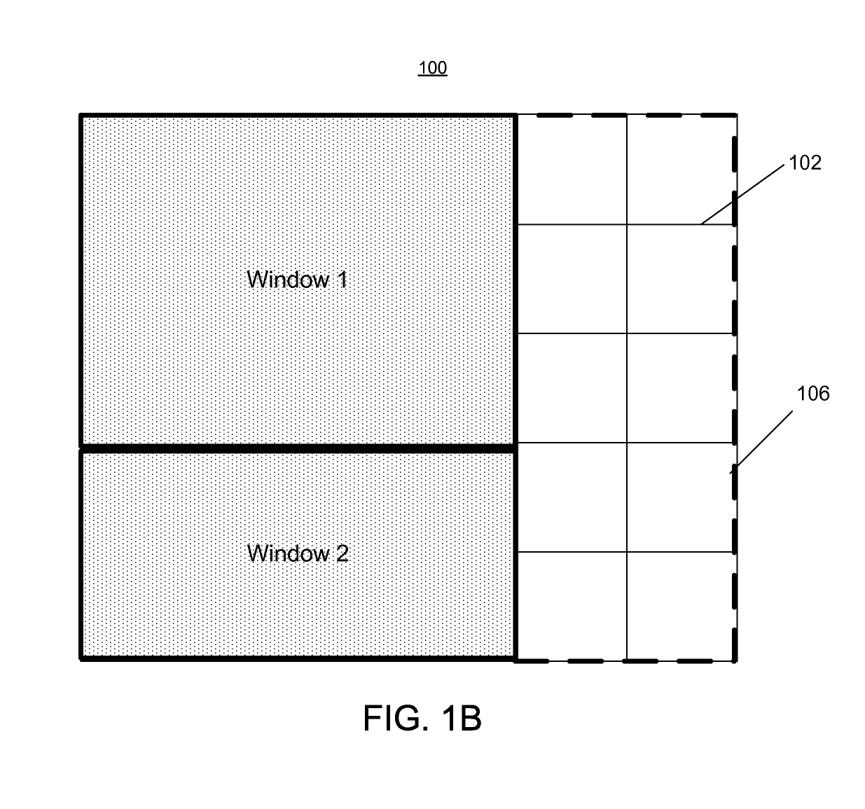

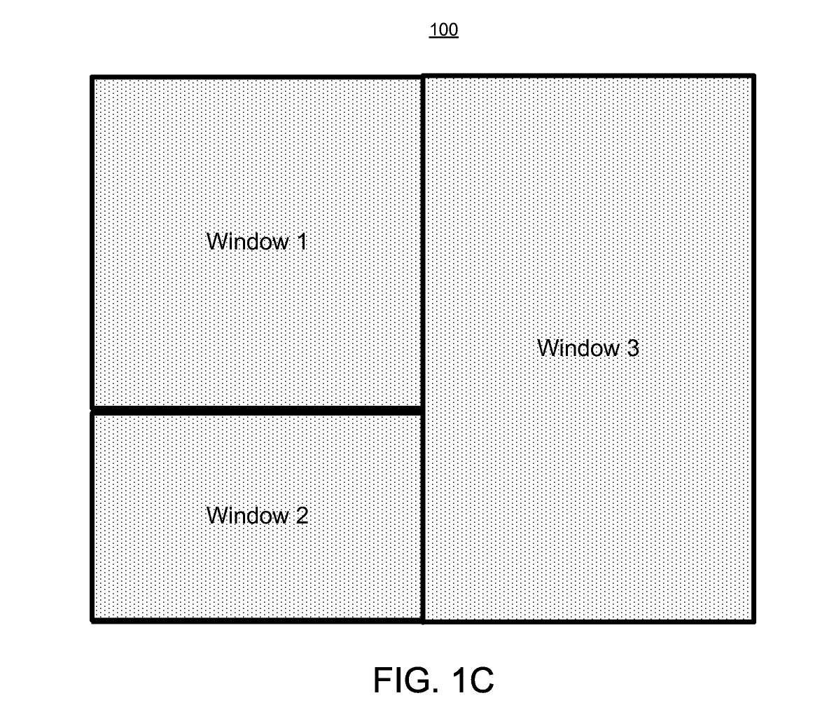

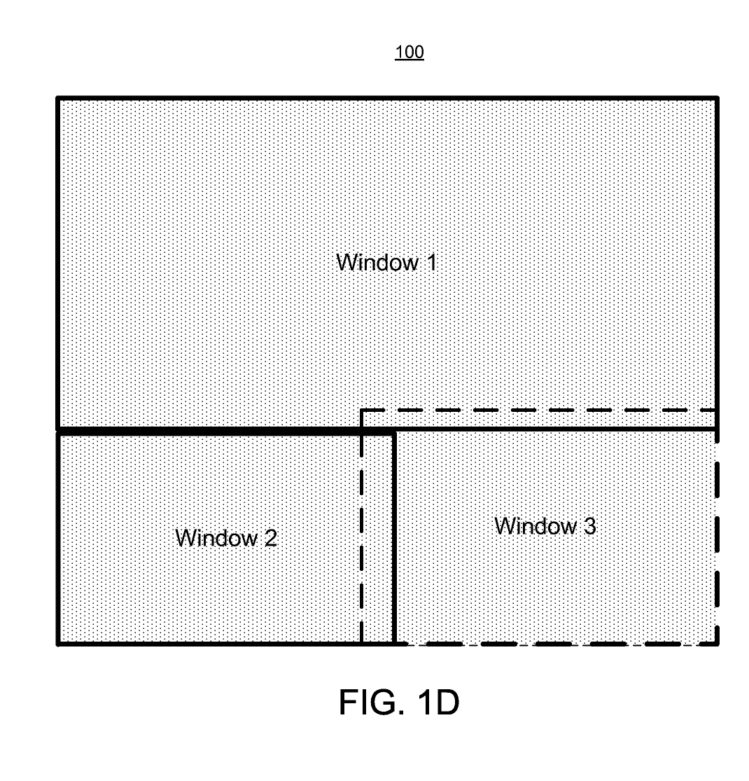

An example of a display area 100 provided by a graphical user interface (GUI) is depicted in FIG. 1A. Specifically, FIG. 1A illustrates display area 100, which includes grid 102, Window 1, first available location 104 and second available location 106.

The display of Window 1 can be used to provide a display of content to the user, for example, content related to an application or web page. The available locations (e.g., first location 104 and second location 106) represent locations in display area 100 that have been identified for the display of an additional window, for example, without overlapping with Window 1.

The available locations (e.g., first available location 104 and second available location 106) can represent candidate locations for the placement (e.g., display) of a new window. In certain aspects, a determination (i.e., a selection) will be made as to which available location, among all available locations in the display area, would be best suited for the placement of the new window. The selection can be based on various types of information, including but not limited to: information related to the available locations, information known about a user, information regarding content to be displayed in the additional window and/or content that is already displayed in one or more windows in the display area.

In one aspect, available locations can be compared based on size and/or location within the display area. For example, first available location 104 can be compared to second available location 106 to determine which is more optimal for the display of an additional window. As depicted in the example of FIG. 1A, first location 104 is more centrally located within display area 100 (as compared to second location 106). As such, a new window (e.g., Window 2) could be displayed in the area corresponding with first location 104.

FIG. 1B illustrates an example of the display of a new window with respect to the configuration illustrated in FIG. 1A. Specifically, FIG. 1B illustrates Window 2, which is displayed at a location in display area 100 corresponding with first location 104, as shown in FIG. 1A. The choice of first location 104 for the display of Window 2 can be based on the size and/or position of first location 104 in display area 100. For example, it may be determined that the central location of first location 104 is more optimally located in display area 100, as compared with the remaining available locations, e.g., second location 106.

In other aspects, the determination of where to display Window 2 could be made based on the type of content that will be displayed therein. For example, windows used to display video content or images may require a certain size or aspect ratio. Accordingly, such windows can be optimally placed in an available location permitting certain size and/or aspect ratio requirements, without overlapping other windows. By way of example, if it is determined that Window 2 is being opened to display video content, the determination of an optimal available location can be restricted to available locations having the proper dimensions needed to support the required aspect ratio.

Placement of a new or additional window can also be based on user configurable settings and/or user history information. For example, the user can specify that windows displaying a static content should be placed to the side of display area 100 and that windows displaying dynamic content (such as video) should be placed at the center of display area 100. By way of further example, user history information, such as, information related to the user's manual placement of windows and/or viewing habits, can be used to determine the optimal placement of a new window.

In certain aspects, one or more windows that are displayed within display area 100 can be resized and/or moved to accommodate the placement of an additional window. FIG. 1C illustrates an example wherein Window 1 and Window 2 (of FIG. 1B) have been resized to accommodate Window 3. Resizing and/or moving of pre-existing windows can be performed in order to place a newly displayed window in an optimal location, as determined using any of the foregoing criteria.

In certain scenarios, each of the available locations (e.g., first location 104 and second location 106) may be smaller than the default display size of a new window. Thus, in certain implementations, the display of the new window can be resized to accommodate the chosen display location. By way of example, referring to FIG. 1C, the default display size of Window 3 could be 100% of display area 100, however, only available location 106 comprises free space within display area 100 in which Window 3 can be positioned. As such, Window 3 can be resized (downsized) to accommodate the display area provided by available location 106.

In another implementation a new window may be partially occluded by one or more other windows, wherein the most significant portions of the window are displayed. FIG. 1D illustrates an implementation wherein Window 3 (defined by the dotted line) has a default display size that is greater than the size of the available location in display area 100. As such, Window 3 is displayed and positioned such that portions of Window 3 are occluded by Window 1 and Window 2. In some implementations, a newly displayed window (e.g., Window 3) may be automatically sized/positioned such that the most significant portions remain visible to the user, with minimal occlusion by one or more other windows.

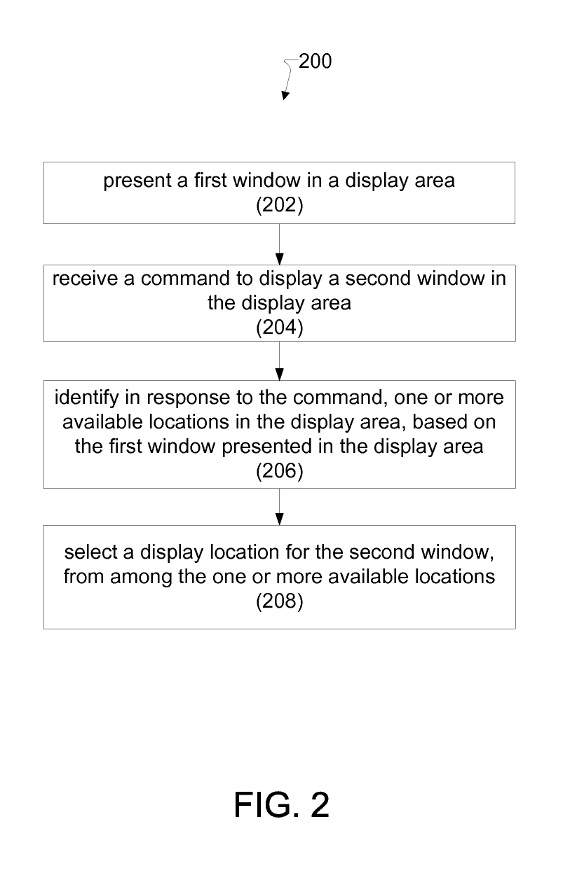

FIG. 2 illustrates an example of steps of a method 200 for managing the placement of one or more windows, according to some aspects of the disclosure. Specifically, method 200 begins with step 202 in which a first window is presented in a display area. The first window can be presented in relation to the display of an application window and/or media content, such as video or images. Furthermore, the first window can be placed in any location within the display area. In certain aspects, the placement of windows (including the first window) will be affected by a grid (e.g., grid 102) in the display area. For example, the edges of windows in the display area may be aligned with contours of the grid that may (or may not) be visible to the user.

Next, in step 204, a command to display a second window is received. The command to display the second window can be received from a user, e.g., a user of an electronic system or device providing for the display area in which the first window is displayed. Additionally, the command can be received via a variety of communication means. For example, the command can be received by any one or more of: a touch-based display, a pointer device (such as a mouse), an optical sensor and/or a microphone (e.g., for use in receiving voice commands).

In step 206, one or more available locations in the display area are identified in response to the command to display the second window. In certain aspects, identification of the available locations can be based on the location of the first window presented in the display area, in addition to one or more other factors, such as the size and/or aspect ratio of unobstructed portions of the display area (e.g., areas not occupied by windows).

In step 208, a display location from among the one or more available locations will be selected. As mentioned above, the determination of an optimal location can be made based on a variety of criteria. For example, the determination of an optimal location can be base on the type of content to be displayed in the newly presented window and/or based on information pertaining to user preferences or history.

In certain aspects, after the display location is determined, a new window will be presented (e.g., displayed) in the display location. Although the new window can be presented in the display location in any size or aspect ratio permitted by the display area, in some aspects the new window will be displayed such that the borders of the new window do not overlap with any other windows in the display area.

Furthermore, a size of the new window can be determined before the new window is displayed in the display area. For example, the size of the new window can be increased or decreased based on the size of the selected display location in which the new window will be presented.

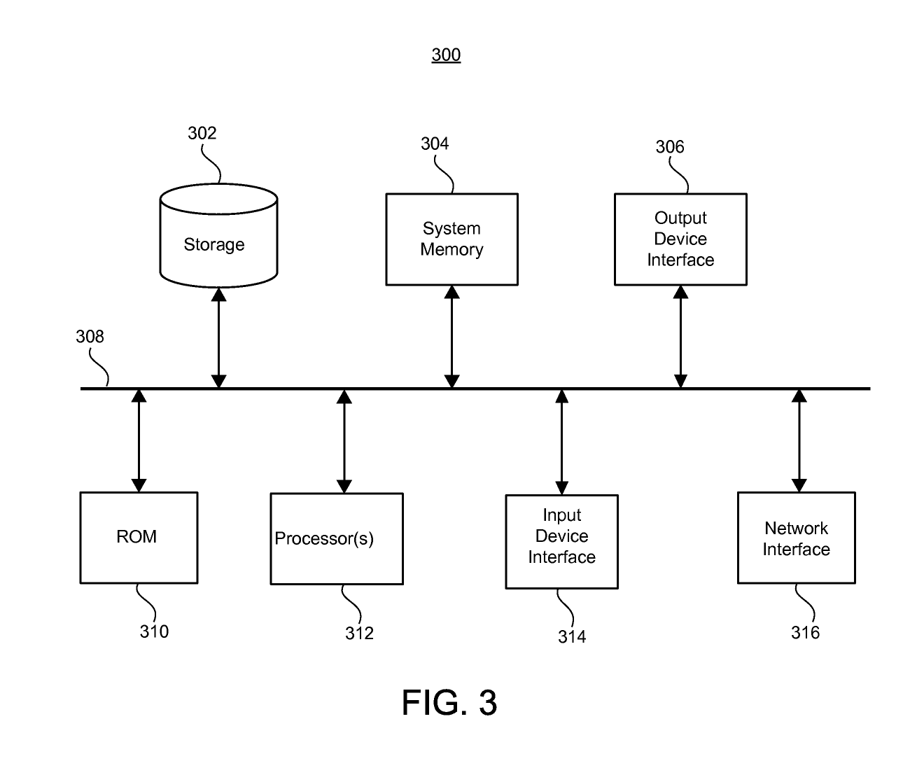

FIG. 3 illustrates an example of an electronic system that can be used for executing the steps of the subject disclosure. In some examples, electronic system 300 can be a single computing device such as a server. Furthermore, in some implementations, electronic system 300 can be operated alone or together with one or more other electronic systems e.g., as part of a cluster or a network of computers.

As illustrated, electronic system 300 comprises storage 302, a system memory 304, an output device interface 306, system bus 308, ROM 310, one or more processor(s) 312, input device interface 314 and a network interface 316. In some aspects, the system bus 308 collectively represents all system, peripheral, and chipset buses that communicatively connect the numerous internal devices of the electronic system 300. For instance, system bus 308 communicatively connects the processor(s) 312 with the ROM 310, the system memory 304, the output device interface 306 and the permanent storage device 302.

In some implementations, the various memory units, the processor(s) 312 retrieve instructions to execute (and data to process) in order to execute the steps of the subject technology. The processor(s) 312 can be a single processor or a multi-core processor in different implementations. Additionally, the processor(s) can comprise one or more graphics processing units (GPUs) and/or one or more decoders, depending on implementation.

The ROM 310 stores static data and instructions that are needed by the processor(s) 312 and other modules of the electronic system 300. Similarly, the processor(s) 312 can comprise one or more memory locations such as a CPU cache or processor in memory (PIM), etc. The storage device 302, is a read-and-write memory device. In some aspects, this device can be a non-volatile memory unit that stores instructions and data even when the electronic system 300 is without power. Some implementations of the subject disclosure can use a mass-storage device (such as solid state, magnetic or optical storage devices) e.g., a permanent storage device 302.

Other implementations can use one or more a removable storage devices (e.g., magnetic or solid state drives) such as permanent storage device 302. Although the system memory can be either volatile or non-volatile, in some examples the system memory 304 is a volatile read-and-write memory, such as a random access memory. System memory 304 can store some of the instructions and data that the processor needs at runtime.

In some implementations, the processes of the subject disclosure are stored in system memory 304, permanent storage device 302, ROM 310 and/or one or more memory locations embedded with the processor(s) 312. From these various memory units, processor(s) 312 retrieve instructions to execute and data to process in order to execute the processes of some implementations of the instant disclosure.

The bus 308 also connects to the input device interface 314 and output device interface 306. The input device interface 314 enables a user to communicate information and select commands to the electronic system 300. Input devices used with the input device interface 314 may include for example, alphanumeric keyboards and pointing devices (also called “cursor control devices”) and/or wireless devices such as wireless keyboards, wireless pointing devices, etc.

Finally, as shown in FIG. 3, bus 308 also communicatively couples the electronic system 300 to a network (not shown) through a network interface 316. It should be understood that the network interface 316 can be either wired, optical or wireless and may comprise one or more antennas and transceivers. In this manner, the electronic system 300 can be a part of a network of computers, such as a local area network (“LAN”), a wide area network (“WAN”), or a network of networks, such as the Internet.

In practice, the methods of the subject technology can be carried out by the electronic system 300. In some aspects, instructions for performing one or more of the method steps of the present disclosure will be stored on one or more memory devices such as the storage 302 and/or the system memory 304.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for managing a display of one or more windows, the method comprising:
presenting a first window in a display area;
receiving a command to display a second window in the display area;
identifying, in response to the command, a plurality of available locations in the display area, based on the first window presented in the display area;
selecting a display location for the second window from among the plurality of available locations; and
presenting the second window in the display location, wherein if the second window and the first window overlap, the second window is sized so that at least one significant portion of the second window is visible and not occluded by an overlapping portion of the first window.

2. (canceled)

3. The method of claim 1, further comprising:
determining a size for the second window based on a size of the display location, and
presenting the second window at the determined size.

4. The method of claim 1, wherein selecting the display location for the second window is based on content that will be displayed in the second window.

5. The method of claim 1, wherein selecting the display location for the second window is based on user configurable settings.

6. The method of claim 1, wherein selecting the display location for the second window is based on user history information.

7. The method of claim 1, further comprising:
presenting the second window in the display location; and
snapping the second window to a grid in the display area.

8. The method of claim 1, further comprising:
receiving a second command to display a third window;
identifying, in response to the second command, a second one or more available locations in the display area based on the first window presented in the display area and the display location for the second window;
selecting a second display location from among the second one or more available locations; and
presenting the third window in the second display location, wherein the third window is a new window not previously displayed in the display area.

9. A system for managing a display of one or more windows, the system comprising:
one or more processors; and
a computer-readable medium comprising instructions stored therein, which when executed by the processors, cause the processors to perform operations comprising:
presenting a first window in a display area;
receiving a command to display a second window in the display area;
identifying, in response to the command, a plurality of available locations in the display area, based on the first window presented in the display area;
selecting a display location for the second window from among the plurality of available locations; and
presenting the second window in the display location, wherein if the second window and the first window overlap, the second window is sized so that at least one significant portion of the second window is visible and not occluded by an overlapping portion of the first window.

10. The system of claim 9, further comprising:
determining a size for the second window based on a size of the display location, and
wherein the second window is presented at the determined size.

11. The system of claim 9, wherein selecting the display location for the second window is based on content that will be displayed in the second window.

12. The system of claim 9, wherein selecting the display location for the second window is based on user configurable settings.

13. The system of claim 9, further comprising:
snapping the second window to a grid in the display area.

14. The system of claim 9, further comprising:
receiving a second command to display a third window;
identifying, in response to the second command, a second one or more available locations in the display area;
selecting a second display location from among the second one or more available locations; and
presenting the third window in the second display location.

15. A computer-readable medium comprising instructions stored thereon, which when executed by a processor, cause the processor to perform operations comprising:
presenting a first window in a display area;
receiving a command to display a second window in the display area;
identifying, in response to the command, a plurality of available locations in the display area, based on the first window presented in the display area;
selecting a display location from among the plurality of available locations;
presenting the second window in the display location, wherein if the second window and the first window overlap, and
the second window is automatically sized so that one or more significant portions of the second window are visible and not occluded by any portion of the first window that continues to overlap the second window.

16. The computer-readable medium of claim 15, further comprising:
determining a size for the second window based on an available size of the display location, and
wherein the second window is presented at the determined size.

17. The computer-readable medium of claim 15, wherein selecting the display location is based on content that will be displayed within the second window.

18. The computer-readable medium of claim 15, wherein selecting the display location is based on user configurable display settings.

19. The computer-readable medium of claim 15, further comprising:
snapping the second window to a grid in the display area.

20. The computer-readable medium of claim 15, further comprising:
receiving a second command to display a third window;
identifying, in response to the second command, a second one or more available locations in the display area based on the first window presented in the display area and the display location for the second window;
selecting a second display location from among the second one or more available locations; and
presenting the third window in the second display location.

21. The method of claim 5, wherein the user configurable settings comprise placing windows displaying static content and windows displaying dynamic content in different locations of the display area.
